(19) United States
(12) Patent Application Publication
(10) Pub. No.: US 2009/0048096 A1
(43) Pub. Date: Feb. 19, 2009

(54) Porphyrin-based electrode catalyst

(76) Inventors: Naoko Iwata, Aichi (JP); Tetsuo Nagami, Aichi (JP); Hidetaka Nishikoori, Shizuoka (JP); Makoto Yuasa, Saitama (JP); Kenichi Oyaizu, Tokyo (JP); Aritomo Yamaguchi, Kanagawa (JP); Mizuki Kitao, Gunma (JP); Takuya Imai, Chiba (JP); Shigeru Kido, Fukushima (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/920,152

(22) PCT Filed: May 10, 2006
(86) PCT No.: PCT/JP2006/309775

§ 371 Date: Nov. 9, 2007

(30) Foreign Application Priority Data
May 10, 2005 (JP) 2005-137698

(51) Int. Cl. B01J 31/18

(52) U.S. Cl. 502/163

(57) ABSTRACT

This invention provides a macrocyclic-organic-compound-based catalyst for reducing oxygen having high oxygen-reducing activity. This oxygen-reducing catalyst comprises a conductive support and, supported thereon, a porphyrin complex represented by formula (I):

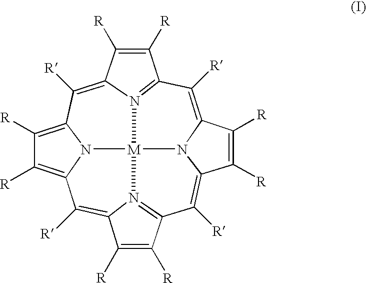

wherein Rs each independently represent a hydrogen atom, an alkyl group having 1 to 6 carbon atoms, a halogen atom, an amino group, a hydroxyl group, a nitro group, a phenyl group, or a cyano group or adjacent Rs together form a methylene chain having 2 to 6 carbon atoms or aromatic ring; R's each independently represent a thienyl group; and M represents a metal atom selected from the group consisting of Cu, Zn, Fe, Co, Ni, Ru, Pb, Rh, Pd, Pt, Mn, Sn, Au, Mg, Cd, Al, In, Ge, Cr, and Ti, provided that M may bind to a halogen atom, an oxygen atom, —OH, a nitrogen atom, NO, or ═CO.

### TECHNICAL FIELD

The present invention relates to an electrode catalyst that uses a porphyrin, compound that effectively reduces oxygen.

### BACKGROUND ART

A fuel cell is a power generating system in which a fuel such as hydrogen or a hydrocarbon and an oxidizing agent such as oxygen are supplied, and which directly converts chemical energy resulting from the consequent oxidoreduction reaction into electric energy. When oxygen (O₂) is reduced in a fuel cell, it is known that superoxide is generated upon one-electron reduction, hydrogen peroxide is generated upon two-electron reduction, and water is generated upon four-electron reduction. Such fuel cells have drawn attention as energy sources that are cleaner than conventional power-generating systems, and practical applications of such fuel cells are extensively examined.

As oxygen-reducing catalysts, noble-metal-based electrode catalysts involving the use of platinum (Pt), palladium (Pd), or the like have been extensively used. Such noble-metal-based electrode catalysts generally have high oxygen-reducing activity; however, they remain problematic in terms of economic efficiency.

Meanwhile, macrocyclic organic compounds such as phthalocyanine or porphyrin are known to be capable of reducing oxygen. In recent years, development of oxygen-reducing catalysts using such macrocyclic organic compounds has been making progress (e.g., JP Patent Publication (kokai) Nos. 57-208073 A (1982), 57-208074 A (1982), 11-253811 A (1999), 2000-157871 A, and 2003-109614 A).

Conventional oxygen-reducing catalysts using macrocyclic organic compounds, however, have lower oxygen-reducing activity than the aforementioned noble-metal-based electrode catalysts, and catalysts using macrocyclic organic compounds are, disadvantageously, more likely to induce two-electron reduction than four-electron reduction. Thus, such catalysts can hardly be put to practical use.

The applicant of the present invention has filed an application for a porphyrin catalyst in which substitution with an alkyl group has taken place at a meso-position as an oxygen-reducing catalyst that can overcome the aforementioned problems (JP Patent Application No. 2004-206148).

Patent Document 1: JP Patent Publication (kokai) No. 57-208073 A (1982)

Patent Document 2: JP Patent Publication (kokai) No. 57-208074A (1982)

Patent Document 3: JP Patent Publication (kokai) No. 11-253811 A (1999)

Patent Document 4: JP Patent Publication (kokai) No. 2000-157871 A

Patent Document 5: JP Patent Publication (kokai) No. 2003-109614 A

### DISCLOSURE OF THE INVENTION

The present invention provides a macrocyclic organic-compound-based oxygen-reducing catalyst having high oxygen-reducing activity.

The present inventors have conducted concentrated studies in order to attain the above object. As a result, they discovered that use of porphyrin in which substitution with a thienyl group has taken place at a meso-position as an electrode catalyst would enable the realization of the above object. This has led to the completion of the present invention.

Specifically, the present invention includes the following inventions.

(1) An oxygen-reducing catalyst comprising a conductive support and, supported thereon, a porphyrin complex represented by formula (I):

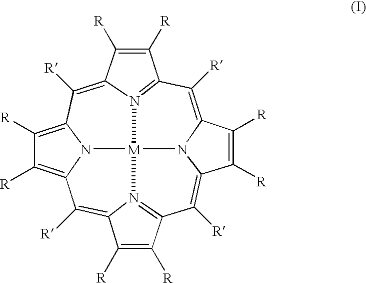

wherein Rs each independently represent a hydrogen atom, an alkyl group having 1 to 6 carbon atoms, a halogen atom, an amino group, a hydroxyl group, a nitro group, a phenyl group, or a cyano group or adjacent Rs together form a methylene chain having 2 to 6 carbon atoms or aromatic ring; R's each independently represent a thienyl group; and M represents a metal atom selected from the group consisting of Cu, Zn, Fe, Co, Ni, Ru, Pb, Rh, Pd, Pt, Mn, Sn, Au, Mg, Cd, Al, In, Ge, Cr, and Ti, provided that M may bind to a halogen atom, an oxygen atom, —OH, a nitrogen atom, NO, or ═CO.

(2) The oxygen-reducing catalyst according to (1), wherein M represents Co.

(3) The oxygen-reducing catalyst according to (1) or (2), wherein R's each independently represent a 3-thienyl group.

(4) An oxygen-reducing catalyst comprising a conductive support and, supported thereon, a porphyrin complex represented by formula (I), which is obtained by heat treatment in an inert gas atmosphere:

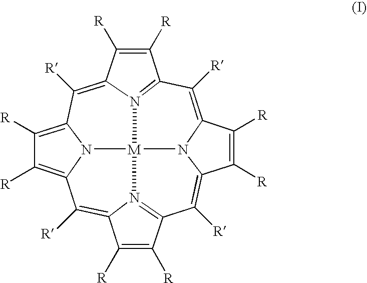

wherein Rs each independently represent a hydrogen atom, an alkyl group having 1 to 6 carbon atoms, a halogen atom, an amino group, a hydroxyl group, a nitro group, a phenyl group, or a cyano group or adjacent Rs together form a methylene chain having 2 to 6 carbon atoms or aromatic ring; R's each independently represent a thienyl group; and M represents a metal atom selected from the group consisting of Cu, Zn, Fe, Co, Ni, Ru, Pb, Rh, Pd, Pt, Mn, Sn, Au, Mg, Cd, Al, In, Ge, Cr, and Ti, provided that M may bind to a halogen atom, an oxygen atom, —OH, a nitrogen atom, NO, or ═CO.

(5) The oxygen-reducing catalyst according to (4), wherein the heat treatment is carried out at 400° C. or higher.

(6) An electrode catalyst for a fuel cell using the oxygen-reducing catalyst according to any of (1) to (5).

(7) A method for producing an oxygen-reducing catalyst comprising a conductive support and, supported thereon, a porphyrin complex represented by formula (I) by performing heat treatment in an inert gas atmosphere:

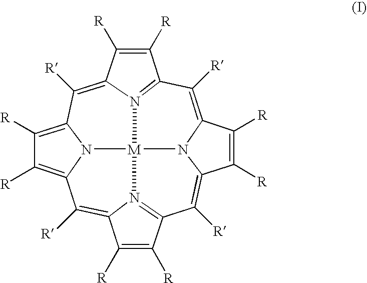

wherein Rs each independently represent a hydrogen atom, an alkyl group having 1 to 6 carbon atoms, a halogen atom, an amino group, a hydroxyl group, a nitro group, a phenyl group, or a cyano group or adjacent Rs together form a methylene chain having 2 to 6 carbon atoms or aromatic ring; R's each independently represent a thienyl group; and M represents a metal atom selected from the group consisting of Cu, Zn, Fe, Co, Ni, Ru, Pb, Rh, Pd, Pt, Mn, Sn, Au, Mg, Cd, Al, In, Ge, Cr, and Ti, provided that M may bind to a halogen atom, an oxygen atom, —OH, a nitrogen atom, NO, or ═CO.

(8) The method according to (7), wherein the heat treatment is carried out at 400° C. or higher.

The present invention provides a porphyrin-based oxygen-reducing catalyst having significantly higher oxygen-reducing activity than conventional phenyl-substituted porphyrin complexes or the like. The oxygen-reducing catalyst of the present invention is useful for an electrode catalyst for a fuel cell and the like.

This description includes part or all of the contents as disclosed in the description and/or drawings of Japanese Patent Application No. 2005-137698, which is a priority document of the present application.

### BRIEF DESCRIPTION OF THE DRAWING

FIG. 1 shows an embodiment of an apparatus for heat treatment at high temperature/ordinary pressure.

### DESCRIPTION OF REFERENCE SYMBOLS

(a) Silica tube
(b) Tubular furnace
(c) Sample dish
(d) Condenser
(e) Three-way cock

### BEST MODES FOR CARRYING OUT THE INVENTION

Hereafter, the present invention is described in detail.

A porphyrin complex in which substitution with a thienyl group has taken place at a meso-position is used as a material for the oxygen-reducing catalyst of the present invention. Specifically, a porphyrin complex represented by formula (I) is used:

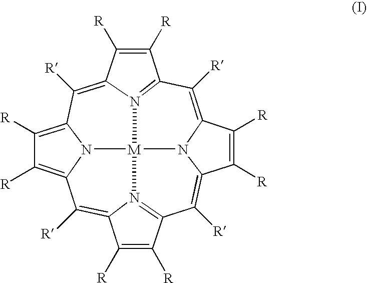

wherein Rs each independently represent a hydrogen atom, an alkyl group having 1 to 6 carbon atoms, a halogen atom, an amino group, a hydroxyl group, a nitro group, a phenyl group, or a cyano group or adjacent Rs together form a methylene chain having 2 to 6 carbon atoms or aromatic ring; R's each independently represent a thienyl group; and M represents a metal atom selected from the group consisting of Cu, Zn, Fe, Co, Ni, Ru, Pb, Rh, Pd, Pt, Mn, Sn, Au, Mg, Cd, Al, In, Ge, Cr, and Ti, provided that M may bind to a halogen atom, an oxygen atom, —OH, a nitrogen atom, NO, or ═CO.

In a porphyrin complex used for a conventional oxygen-reducing catalyst, a phenyl group or a substituted phenyl group was located at a meso-position. In the porphyrin complex used for the oxygen-reducing catalyst of the present invention, however, the substituent (i.e., R′) at the meso-position is a thienyl group (preferably a 3-thienyl group).

The term “an alkyl group having 1 to 6 carbon atoms” used herein may refer to a linear or branched-chain alkyl group. Examples thereof include methyl, ethyl, n-propyl, isopropyl, n-butyl, s-butyl, t-butyl, isobutyl, n-pentyl, s-pentyl, isopentyl, and neopentyl groups. Such alkyl groups may have substituents, such as halogen atoms, amino groups, or hydroxyl groups. R′ preferably represents an alkyl group having 1 to 5 carbon atoms, and more preferably represents an alkyl group having 2 to 4 carbon atoms.

Examples of R include a hydrogen atom, an alkyl group having 1 to 6 carbon atoms, a halogen atom, an amino group, a hydroxyl group, a nitro group, a phenyl group, and a cyano group, with a hydrogen atom and an alkyl group being preferable. Alternatively, adjacent Rs may together form a methylene chain having 2 to 6 carbon atoms or aromatic ring. Examples of such aromatic ring include fused aromatic rings such as benzene and naphthalene rings.

The porphyrin complex used in the present invention has an N4-chelate structure formed by a porphyrin skeleton having the aforementioned group and a metal atom M. Examples of the metal atom M include Cu, Zn, Fe, Co, Ni, Ru, Pb, Rh, Pd, Pt, Mn, Sn, Au, Mg, Cd, Al, In, Ge, Cr, and Ti, with Co, Fe, or the like being preferable. Further, such metal atom M may comprise a ligand having a halogen atom, an oxygen atom, a hydroxyl group, a nitrogen atom, NO, CO, or the like ligated thereto.

Subsequently, a method for producing the porphyrin complex used in the present invention is described.

A porphyrin skeleton in which substitution with a thienyl group has taken place at a meso-position can be produced in the following manner with the use of a pyrrole compound and an aldehyde compound.

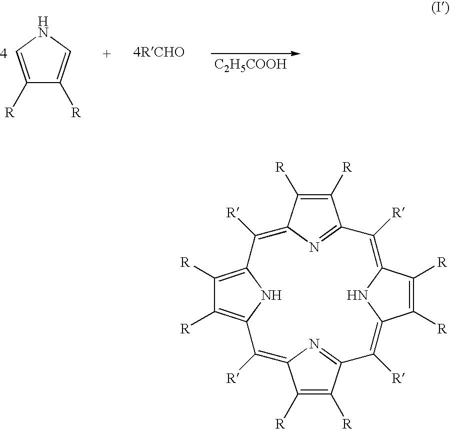

wherein R and R′ are as defined above.

A base such as pyridine, and propionic acid, or the like is added to a reaction vessel, and the resulting mixture is heated at, for example, about 50° C. to 100° C. A pyrrole compound and an aldehyde compound are added thereto, followed by agitation. The duration of agitation varies depending on a reaction temperature, and it is generally about 1 to 5 hours. After the completion of the reaction, the reaction solution is washed with an aqueous alkaline solution such as an aqueous sodium hydroxide solution and then with water. An organic layer is separated and dried over magnesium sulfate or the like to remove the solvent by distillation. Subsequently, the residue is purified by a conventional means of purification, such as chromatography or recrystallization, to obtain a target alkyl-substituted porphyrin (I′).

Subsequently, the thus-obtained thiophene-substituted porphyrin (I′) and a metal atom are used to form a chelate. A chelate compound is easily formed by mixing salt or a complex of a desired metal atom with porphyrin (I′). For example, a target cobalt-porphyrin complex can be obtained by thoroughly dissolving porphyrin (I′) in a solvent such as DMF, adding cobalt acetate tetrahydrate thereto, heating the mixture under reflux in an argon atmosphere, and purifying the reaction mixture by a common technique.

The oxygen-reducing catalyst of the present invention is formed by supporting the aforementioned porphyrin complex (I) on a conductive support in accordance with a common technique. For example, a slurry, paste, or suspension containing the porphyrin complex (I) is prepared, a conductive support is soaked therein or coated with the slurry or paste, and the support is then dried. Thus, the oxygen-reducing catalyst of the present invention can be produced. Examples of a solvent (a supporting solvent) used for the slurry, paste, or suspension include a halogenated hydrocarbon solvent such as chloroform or tetrachloroethane, acetonitrile, tetrahydrofuran, a monocyclic aromatic hydrocarbon solvent (such as benzene or toluene), and a C₁₋₆ lower alcohol (such as propanol or butanol).

A conductive support is not particularly limited. For example, carbon materials, such as carbon black, graphite, carbon fiber, carbon nanotubes, or carbon nanofiber, may be used from the viewpoint of good conductivity and cost effectiveness. Due to its large surface area per unit weight, a conductive support is preferably in particulate form. In such a case, diameters of particles of a conductive support are preferably between 0.03 μm and 0.1 μm. Further, particles of a conductive support preferably are disposed in a structure in which such primary particles are connected to each other.

The amount of the porphyrin complex supported on the conductive support is generally 40% to 80% by weight, and preferably 50% to 60% by weight, relative to the conductive support.

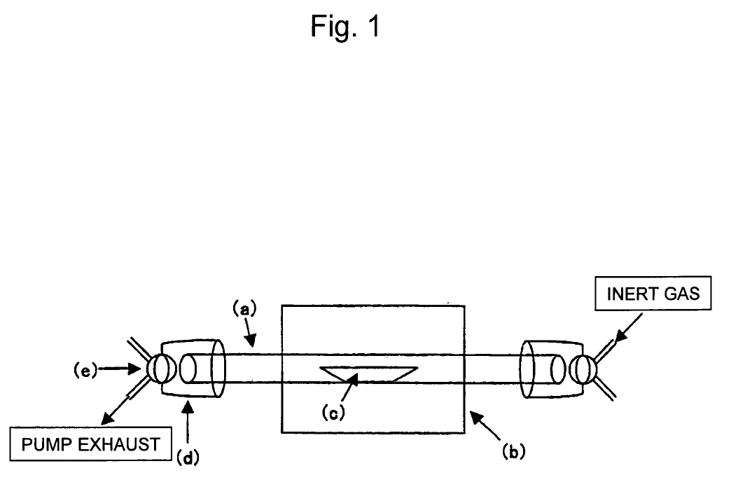

Also, the present inventors discovered that heat treatment of the conductive support comprising the porphyrin complex (I) supported thereon obtained in the above-described manner in an inert gas atmosphere could further improve the activity of the oxygen-reducing catalyst for reducing oxygen. Heat treatment can be carried out in the following manner using an apparatus for heat treatment at high temperature/ordinary pressure as shown in FIG. 1, for example.

A conductive support comprising a porphyrin complex (I) supported thereon is placed in a silica tube (a), and the tube is filled with an inert gas and hermetically sealed or is aerated with an inert gas to raise the temperature in the tube. At the time of heat treatment, the atmospheric pressure in the tube is not particularly limited. For example, it is preferably roughly an ordinary pressure between 0.8 atm and 1.2 atm. Heat treatment is carried out preferably at 300° C. or higher, more preferably at 400° C. or higher, and most preferably at 550° C. or higher. The upper temperature limit for heat treatment is generally 600° C., preferably 550° C., and most preferably 500° C. The duration of heat treatment varies depending on the temperature. It is generally 1 to 40 hours and preferably 1 to 3 hours. Examples of an inert gas that can be used in the present invention include noble gases such as helium, neon, and argon, nitrogen, and mixed gases thereof. After the heat treatment, the support is cooled to room temperature to obtain the electrode catalyst of the present invention. The electrode obtained by the above-described manner via heat treatment (i.e., a sintered electrode) has a better oxygen-reducing activity than the electrode before heat treatment.

Also, the oxygen-reducing catalyst of the present invention may comprise another four-electron oxygen-reducing catalyst involving the use of noble metals such as platinum or palladium on the support in addition to the porphyrin complex (I).

The oxygen-reducing catalyst of the present invention can be used as an electrode catalyst for a fuel cell, such as a solid polymer fuel cell. For example, the electrode catalyst of the present invention is dispersed in an electrolyte-containing solution, an electrolytic film is coated with the resulting dispersion, and the coated film is dried. Thus, an electrode catalyst for a fuel cell having an electrode catalyst on the electrolytic film surface can be obtained. Further, a carbon cloth or the like is thermally welded on the catalyst layer surface with the application of pressure to prepare an electrode-electrolyte assembly.

Hereafter, the present invention is described in greater detail with reference to the examples, although the technical scope of the present invention is not limited thereto.

### EXAMPLE 1

### Synthesis of 5,10,15,20-tetra(3-thienyl) porphyrin

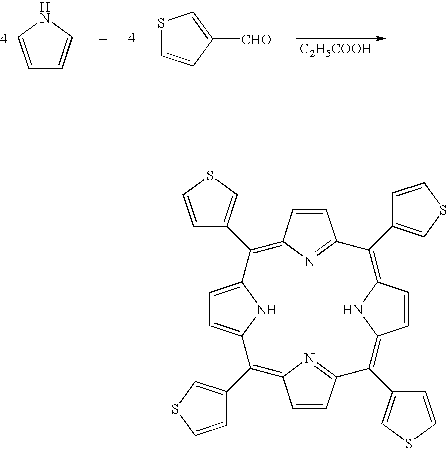

Porphyrin in which all 4 meso-positions had been substituted with 3-thienyl groups was synthesized.

Propionic acid (200 ml) was added to a 2-L four-neck flask to heat it to 140° C., and pyrrole (5.6 ml, 81 mmol) and 3-thiophene aldehyde (7.0 ml, 80 mmol) were added thereto. After the completion of the reaction, the reaction solution was cooled, cold methanol was added to perform suction filtration, the residue was dissolved in chloroform, and the resultant was washed twice with water, an aqueous sodium hydroxide solution, and water. The organic layer was dried over magnesium sulfate, and a solvent was removed by distillation. The residue was eluted with chloroform via column chromatography on silica gel (5 cm (φ)×50 cm), a fraction containing a target product was collected, a solvent was removed by distillation, and the resulting crystal was recrystallized from chloroform/hexane to result in a title compound (2.3 g; yield: 18%). The product was identified by UV assay (UV-2100, Shimadzu Corporation), ¹H-NMR (JNM AL-300), and FAB-MASS (JEOL JMS-SX102A).

UV-vis (CHCl₃): λmax=421, 521, 556, 596, and 654 nm

¹H-NMR (300 MHz, CDCl₃): δ (ppm): −2.7 (s, 2H), 7.7 (q, 4H), 8.0 (d, 4H), 8.0 (d, 4H), 9.0 (s, 8H).

### EXAMPLE 2

### Synthesis of 5,10,15,20-tetra(3-thienyl) porphyrin cobalt complex (CotthP)

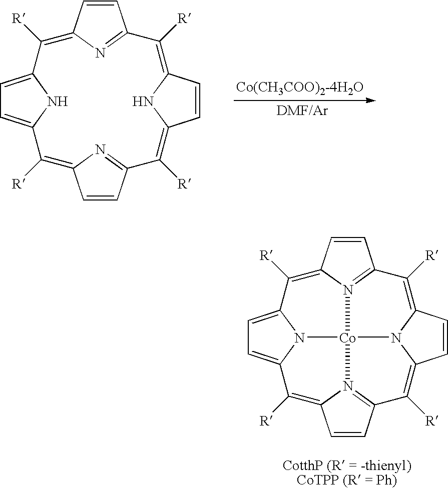

The cobalt complex of tetra(3-thienyl) porphyrin obtained in Example 1 was synthesized.

DMF (100 ml) and 300 mg of tetra(3-thienyl) porphyrin obtained in Example 1 were added to and dissolved in a 500-ml round-bottom flask, and the resultant was deaerated with argon gas.

Cobalt acetate tetrahydrate (585 mg) was dissolved ultrasonically therein, and the resultant was heated under reflux at 150° C. to 160° C. for 2 hours using a Dimroth reflux condenser equipped with an argon balloon. After the completion of the reaction, the resultant was ice-cooled to 4° C. or lower, and excess ice-cooled water was added for recrystallization (DMF/water). The crystals were recovered by suction filtration using a glass filter and then dried in vacuo (120° C., 6 hours) to result in a title compound (CotthP) (267 mg, 82%). The product was identified by UV assay (UV-2100, Shimadzu Corporation) and FAB-MASS (JEOL JMS-SX102A).

### EXAMPLE 3

### Supporting of Porphyrin Complex on Conductive Support (Carbon)

CotthP obtained in Example 2 was used as a porphyrin complex. Carbon black (Ketjen Black) was used as a conductive support.

Carbon black (500 mg) was dispersed ultrasonically in chloroform. The dispersion was agitated at room temperature to 58° C. for 1.5 hours using a magnetic stirrer, high shear stress-type agitator, or the like. CotthP was added thereto using a syringe, and the mixture was agitated while cooling to 30° C. for 3 to 6 hours. After the completion of agitation, chloroform was removed by distillation, and the residue was dried in vacuo to obtain porphyrin-complex-supporting carbon.

### EXAMPLE 4

### Heat Treatment of Porphyrin-Complex-Supporting Carbon

The porphyrin-complex-supporting carbon produced in Example 3 was subjected to heat treatment at various temperatures using an apparatus for heat treatment at high temperature/ordinary pressure as shown in FIG. 1 to produce a sintered electrode. Heat treatment was carried out under the following conditions.

Temperature: 300° C., 400° C., 500° C., 550° C., 600° C.

Rate of temperature increase: 5° C./min

Inert gas: argon (ordinary pressure)

Duration: 2 hours (naturally cooled to room temperature after the completion of heat treatment)

### EXAMPLE 5

### Electrochemical Assay

Electrochemical properties of the sintered electrode produced in Example 4 were assayed.

### Preparation of Modified Electrode

An edge plane pyrolytic graphite electrode (radius: 3.00 mm; area: 0.28 cm²) was used. The electrode was subjected to pre-treatment by polishing with waterproof abrasive paper (#1000), followed by ultrasonic cleansing in ion-exchanged water. The porphyrin-complex-supporting carbon black (2 mg) prepared in Example 4 was dispersed in 0.25 ml of a solution that was 5% by weight Nafion®. A 20-μl fraction was separated from the solution and cast on the electrode surface.

### Evaluation of Oxygen-Reducing Properties via Cyclic Voltammetry (CV) Measurement

Oxygen-reducing properties of various modified electrodes were evaluated via CV measurement. Measurement was carried out at room temperature in an oxygen or argon atmosphere, and the first sweeping was recorded. Specific conditions for measurement were as follows.

Instrument used: Potentiostat [Nikkou Keisoku, DPGS-1]
Function generator [Nikkou Keisoku, NFG-5]
X-Y recorder [Rikendenshi, D-72DG]

Cell solution: 1.0 M HClO₄

Working electrode: Modified electrode

Reference electrode: Saturated calomel electrode (SCE)

Counter electrode: Platinum electrode

Sweeping rate: 100 mV/sec

Sweeping range: 600 to −600 mV

The results of assaying the peak potential of the porphyrin-complex-modified electrode of the present invention determined by CV measurement are shown in Table 1.

TABLE 1

| Temperature for | |
|---|---|
| heat treatment | Peak potential Ep |
| (° C.) | (V vs SCE) |
| Without heat treatment | 0.38 |
| 300 | 0.41 |
| 400 | 0.40 |
| 500 | 0.47 |
| 550 | 0.41 |
| 600 | 0.42 |

Ep: Peak potential of oxygen-reducing wave in cyclic voltammetry

As is apparent from the results shown above, the peak potentials obtained when the oxygen-reducing catalyst of the present invention was used were significantly enhanced.

### INDUSTRIAL APPLICABILITY

The porphyrin complex used in the present invention has a high oxygen-reducing potential and is useful as an electrode catalyst for a fuel cell, for example.

All publications, patents, and patent applications cited herein are incorporated herein by reference in their entirety.

1. An oxygen-reducing catalyst comprising a conductive support and, supported thereon, a porphyrin complex represented by formula (I): 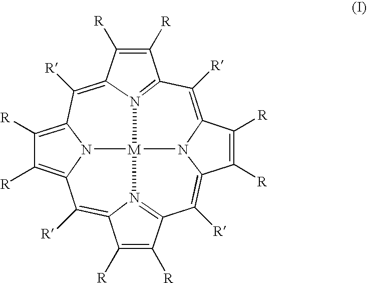
wherein Rs each independently represent a hydrogen atom, an alkyl group having 1 to 6 carbon atoms, a halogen atom, an amino group, a hydroxyl group, a nitro group, a phenyl group, or a cyano group or adjacent Rs together form a methylene chain having 2 to 6 carbon atoms or aromatic ring; R's each independently represent a thienyl group; and M represents a metal atom selected from the group consisting of Cu, Zn, Fe, Co, Ni, Ru, Pb, Rh, Pd, Pt, Mn, Sn, Au, Mg, Cd, Al, In, Ge, Cr, and Ti, provided that M may bind to a halogen atom, an oxygen atom, —OH, a nitrogen atom, NO, or ═CO.

2. The oxygen-reducing catalyst according to claim 1, wherein M represents Co.

3. The oxygen-reducing catalyst according to claim 1 or 2, wherein R's each independently represent a 3-thienyl group.

4. An oxygen-reducing catalyst comprising a conductive support and, supported thereon, a porphyrin complex represented by formula (I), which is obtained by heat treatment in an inert gas atmosphere: 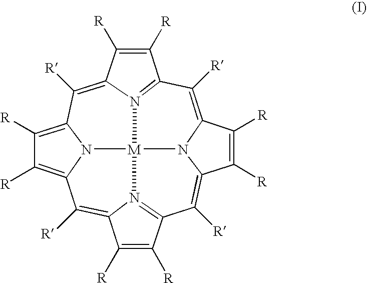
wherein Rs each independently represent a hydrogen atom, an alkyl group having 1 to 6 carbon atoms, a halogen atom, an amino group, a hydroxyl group, a nitro group, a phenyl group, or a cyano group or adjacent Rs together form a methylene chain having 2 to 6 carbon atoms or aromatic ring; R's each independently represent a thienyl group; and M represents a metal atom selected from the group consisting of Cu, Zn, Fe, Co, Ni, Ru, Pb, Rh, Pd, Pt, Mn, Sn, Au, Mg, Cd, Al, In, Ge, Cr, and Ti, provided that M may bind to a halogen atom, an oxygen atom, —OH, a nitrogen atom, NO, or ═CO.

5. The oxygen-reducing catalyst according to claim 4, wherein the heat treatment is carried out at 400° C. or higher.

6. An electrode catalyst for a fuel cell using the oxygen-reducing catalyst according to any one of claims 1 to 5.

7. A method for producing an oxygen-reducing catalyst comprising a conductive support and, supported thereon, a porphyrin complex represented by formula (I) by performing heat treatment in an inert gas atmosphere: 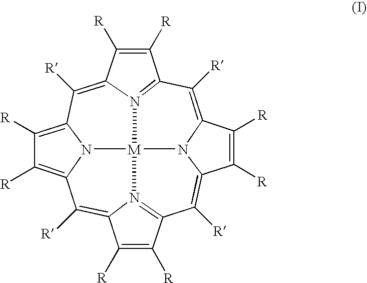
wherein Rs each independently represent a hydrogen atom, an alkyl group having 1 to 6 carbon atoms, a halogen atom, an amino group, a hydroxyl group, a nitro group, a phenyl group, or a cyano group or adjacent Rs together form a methylene chain having 2 to 6 carbon atoms or aromatic ring; R's each independently represent a thienyl group; and M represents a metal atom selected from the group consisting of Cu, Zn, Fe, Co, Ni, Ru, Pb, Rh, Pd, Pt, Mn, Sn, Au, Mg, Cd, Al, In, Ge, Cr, and Ti, provided that M may bind to a halogen atom, an oxygen atom, —OH, a nitrogen atom, NO, or ═CO.

8. The method according to claim 7, wherein the heat treatment is carried out at 400° C. or higher.
